(19) United States
(12) Patent Application Publication
(10) Pub. No.: US 2008/0182884 A1
(43) Pub. Date: Jul. 31, 2008

(54) Fungicide compositions

(76) Inventor: Laurent Cornette, Othee (BE)

Correspondence Address: NORRIS MCLAUGHLIN & MARCUS, P.A., P O BOX 1018, SOMERVILLE, NJ, 08876, US

(21) Appl. No.: 11/700,508

(22) Filed: Jan. 31, 2007

(51) Int. Cl. A01N 47/44

(52) U.S. Cl. 514/383; 514/634

(57) ABSTRACT

The invention relates to a method of using fungicides for protecting peanut plants, which comprises applying to the field a composition comprising dodecylguanidine as active ingredient, and such compositions useful for treating peanuts crops against early leaf spot and late leaf spot.

### BACKGROUND OF THE INVENTION

1. Field of the Invention

The invention relates to the field of fungicidal compositions. More particularly, it relates to the use of dodecylguanidine as a fungicide against diseases of peanuts.

2. Description of Related Art

Peanut (Arachis hypogea L.) is an annual plant which is very important to the economy of the United States. Unfortunately, this crop is subject to hard-to-control foliar and soil-born diseases.

Early leaf spot, caused by Cercospora arachidicola Hori, also known as Mycosphaerella arachidis Deighton and late leaf spot, caused by Cercosporidium personatum (Berk. & M. A. Curtis) De, also known as Cercospora personata (B.&C.) Ellis are the most common and damaging foliar diseases in peanuts. Failure to control these diseases through the use of timely fungicide applications can severely reduce yields. This is acknowledged in many publications and has a great impact on economy.

Symptoms of both diseases first appear on the leaves as small yellow to brown flecks. Early leaf spot is characterized by circular spots that are brown to reddish brown on the upper surface and almost orange on the lower surface. The lesions always have a bright yellow halo and are about the diameter of a No. 2 pencil. Late leaf spot lesions range in color from dark brown to almost black and have a feathery margin. They are usually similar in size and shape to those of early leaf spot. A pale yellow halo is rarely associated with lesions of late leaf spot and is only seen in June and early July. Some years, spots of early and late leaf spot may be seen on the same leaflets. On peanuts severely damaged by early or late leaf spot, spots similar in color but larger than those found on the leaves are commonly seen on the leaf petiole. Due to similarities in spot color on some peanut cultivars, early and late leaf spot may be difficult to distinguish.

Fungicides are known and currently used for preventing the foliar and soil-born diseases in peanuts. Historically, the first fungicides used were contact fungicides with broad spectrum such as for instance copper and the aromatic fungicide chlorothalonil, sold under trademark names such as Bravo™, Echo™ and Terranil™. There is no major resistance problem against these fungicides. However, the problem linked to contact fungicides is that they do not penetrate inside the plant and have therefore a limited efficacy. Such efficacy may be dramatically reduced when rain falls after application on the leaves.

Triazole fungicides such as tebuconazole, sold under the trademark Folicur™, and propiconazole, sold under the trademark Tilt™ are systemic fungicides which go deep into the leaf. The efficacy of systemic fungicides is greater than that of contact fungicides, but the problem is that resistance of fungi to these fungicides is frequently observed after a while. Resistance management has naturally become a major concern following the registration of tebuconazole and propiconazole for application on peanuts. Tilt™ fungicide is recommended primarily for the control of early leaf spot, while Folicur™ will control early and late leaf spot, peanut rust, white mold, and limb rot. Both of these fungicides are systemic in peanuts and have a single-site mode of action. Control failures due to insensitivity or resistance are much more likely for fungicides that act at single rather than at multiple action sites, such as chlorothalonil (Bravo™, Echo™, Terranil™).

In practice, leaf spot resistance to these triazoles has been observed. Further, repeated applications of triazole fungicides could cause a slow erosion of disease control due to a gradual loss of sensitivity in the target pathogen population. Of the common fungal pathogens of peanuts, the early and late leaf spot fungi are most likely to become insensitive or resistant to triazole fungicides.

Peanut growers cannot entirely rely on triazole fungicides to control foliar and soilborne diseases of peanuts. Limiting the number of triazole fungicide applications to a block of four sprays or the addition of a contact fungicide tank-mix partner, such as chlorothalonil, greatly reduce the risk of a control failure without compromising fungicide efficacy.

A further family of fungicides consists of strobilirubines, which comprises trifloxystrobin (sold under trademark Flint™) and azoxystrobin (sold under trademark Abound™). These fungicides are efficient, but the problem of resistance also exists.

Management of the fungicide treatments led researchers to the elaboration of somewhat complex programs taking into account climatic conditions, in particular rain conditions. Several fungicides are generally combined in a given sequence in order to both obtain satisfying results and manage resistance.

### SUMMARY OF THE INVENTION

A method of using fungicides for protecting peanut plants is provided. The method is performed by applying, in an effective dose, a composition containing dodecylguanidine to a peanut plant. The method and composition are used, for example, for protecting plants against early leaf spot and late leaf spot. In one embodiment the dodecylguanidine is in the form of a salt such as hydrochloride or acetate. In another embodiment, the composition also comprises another fungicide, such as, for example, tebuconazole, propiconazole or a combination of the two.

In an alternate embodiment, the method applying, in an effective dose, a composition containing dodecylguanidine is part of a program comprising the application of several fungicides, not all which applications include dodecylguanidine.

### DETAILED DESCRIPTION OF THE INVENTION

It has now been surprisingly found that dodecylguanidine, a fungicide which is known for having an effect on fruit trees in moderate climates may also be used with success on peanut plants, which is of a dramatically different nature.

The present invention covers a method of using fungicides in peanut growing, which comprises applying to the plants a composition comprising dodecylguanidine as an active ingredient. Dodecylguanidine may be in the form of a salt, preferably hydrochloride and acetate. The composition of the invention may also comprise another fungicide preferably chosen amongst tebuconazole and propiconazole. Preferably, the composition comprises between 20 and 90% w/w dodecylguanidine. The preferred formulation is a suspension concentrate (SC) comprising 400 g/l of dodecylguanidine. In the method of the invention, the active ingredient (a.i.) dodecylguanidine is preferably applied in an effective dose comprised between 0.24 and 0.80 lbs a.i./acre. According to a preferred embodiment of the invention, the field is treated by means of a program comprising several fungicide applications, not all applications comprising dodecylguanidine. It has been shown that the compositions comprising dodecylguanidine used on peanuts according to the methods of the invention are efficient against peanuts early leaf spot and against peanuts late leaf spot. The invention also relates to a composition useful against peanuts early leaf spot and late leaf spot, wherein said composition comprises dodecylguanidine as active ingredient. Dodecylguanidine is preferably in the form of a salt, for instance hydrochloride or acetate. The compositions of the invention may also comprise another fungicide chosen amongst tebuconazole and propiconazole. Preferably, the compositions of the invention comprise between 20 and 90% w/w dodecylguanidine.

### EXAMPLE 1

A first field trial was conducted in 2004 in the United States. The peanut variety Georgia Green, chosen for its great sensibility to leaf spot, was treated with various fungicides to evaluate the comparative efficacy against this peanut disease. Midseason foliar treatments were applied using as application equipment a CO₂ pressurized belt-pack sprayer using 2 liter bottles and a 20 gallons per acre broadcast boom with three Conejet TX-SS6 hollow cone nozzles per row at 40 PSI.

Six treatments (1-6) were respectively applied on June 18, June 29, July 13, July 27, August 2, August 9 and August 26. In this trial, all applications in a given plot were performed with the same fungicide. The experimental design was:

randomized complete blocks with five replicates,

one 2-row bed (25×6 ft) per plot, 36-inch row spacing,

8-foot alleyways between blocks.

Early and late leaf spot were rated using the Florida peanut leaf spot scoring system where 1=no disease, 2=very few lesions in canopy, 3=few lesions in lower and upper leaf canopy, 4=some lesion lower and upper leaf canopy (inferior or equal to 10 percent), 5=lesions noticeable in upper canopy with some defoliation (inferior or equal to 25 percent), 6=lesions numerous with significant defoliation (inferior or equal to 50 percent), 7=lesions numerous with heavy defoliation (inferior or equal to 75 percent), 8=numerous lesions on few remaining leaves with severe defoliation (inferior or equal to 90 percent) and 10=plants defoliated or dead.

The results of the trial are given in table 1 below. Since the climatic conditions were particularly wet, the results are considered to be representative. In this table, dodine stands for a formulation of dodecylguanidine acetate at a concentration of 400 g/l. Echo™ 720 is a formulation of chlorothalonil at 720 g/l sold by Sipcam Agro USA, Inc.

TABLE 1

| | | | | Leaf spot on | Leaf spot |
|---|---|---|---|---|---|
| | | | | Aug. 30, | on Sep. |
| Treatment | Rate/acre | | Applications | 2004 | 10, 2004 |
| Echo ™ 720 | 1.5 | pint | 1–6 | 3.6 | 5.0 |
| Dodine | 24 | fl oz | 1–6 | 3.6 | 5.0 |
| Dodine | 32 | fl oz | 1–6 | 3.1 | 4.6 |

### EXAMPLE 2

A second field trial was conducted in 2005 to evaluate the efficacy of dodine for the control of peanuts diseases.

Seven treatments (1-7) were respectively applied on June 7, June 21, July 5, July 19, August 2, August 16 and August 30.

The experimental design was as for example 1. Bravo Weather Stick™ (Bravo W'Stick) is a formulation of chlorothalonil sold by Syngenta and comprising 720 g/l of active ingredient.

TABLE 2

| | | | | Leaf spot | Leaf spot on |
|---|---|---|---|---|---|
| | | | | on Aug. | Sep. 23, |
| Treatment | Rate/acre | | Applications | 11, 2005 | 2005 |
| Bravo W'Stick | 1.5 | pt | 1–7 | 3.8 | 6.3 |
| Bravo ™ W'Stick + | 1.0 | pt | 1, 2 & 7 | 3.7 | 4.9 |
| dodine | 15 | fl oz | 3 to 6 | | |
| Dodine | 15 | fl oz | 1–7 | 3.7 | 6.2 |
| Dodine | 20 | fl oz | 1–7 | 3.3 | 5.4 |
| Dodine | 24 | fl oz | 1–7 | 3.1 | 5.7 |

The results of August 11 are more interesting, since they are taken before the plant cells begin to be destroyed. However, it is worth noting that when using a combination of chlorothalonil for applications 1, 2 and 7 and dodine for applications 3 to 6, the results are really better on September 23, i.e. the plants are in a far better state on that date when using an alternation of Bravo W'Stick for applications 1, 2 and 7 and dodine for applications 3 to 6.

### EXAMPLE 3

Experimental conditions were as in Example 2 and the results are given in table 3.

Folicur™ 3.6 F is a composition of tebuconazole sold by Bayer Cropscience, comprising 432 g/l of active ingredient.

TABLE 3

| | | | Leaf spot on | Leaf spot on |
|---|---|---|---|---|
| | | | Aug. 11, | Sep. 23, |
| Treatment | Rate/acre | Applications | 2005 | 2005 |
| Bravo W'Stick | 1.5 pt | 1, 2 & 7 | 3.3 | 5.3 |
| Folicur ™ 3.6 F | 7.2 fl oz | 3 to 6 | | |
| Bravo W'Stick | 1.0 pt | 1, 2 & 7 | 3.2 | 4.2 |
| [Folicur ™ | 7.2 + 15 fl | 3 to 6 | | |
| 3.6 F + dodine] | oz | | | |
| Bravo W'Stick | 1.0 pt | 1, 2 & 7 | 3.7 | 4.9 |
| dodine | 15 fl oz | 3 to 6 | | |

The use of dodine composition in applications 3 to 6 leads to a better result than the use of Folicur™ in these applications. The result is improved at a late stage (September 23) when using dodine in combination with Folicur™ in these applications.

One important aspect of the invention is the fact that the dodecylguanidine is a semi-systemic fungicide able to rapidly penetrate in the leaves of peanuts, thus becoming quickly efficient. As a consequence, dodine shows several assets compared to the traditional chlorothalonil such as fast penetration, rain fastness, and kick-back effect (i.e. they are effective against infection even when applied after the infection occurred).

In addition, when dodine is used as part of treatment programs comprising other fungicides, the use of an alternative fungicide helps reduce the risk of resistance buildup. The fact that dodecylguanidine is a molecule of a different kind from the fungicides used traditionally in peanuts is an additional advantage in that respect.

1. A method of using fungicides for protecting peanut plants comprising the step of: applying to the plants a composition comprising dodecylguanidine.

2. A method according to claim 1, wherein dodecylguanidine is in the form of a salt.

3. A method according to claim 2 wherein the salt is hydrochloride or acetate.

4. A method according to claim 1, wherein the composition also comprises another fungicide which is tebuconazole, propiconazole or a combination thereof.

5. A method according to claim 1, wherein the composition comprises between 20 and 90% w/w dodecylguanidine.

6. A method according to claim 1, wherein dodecylguanidine is applied in an effective dose comprised between 0.24 and 0.80 lbs a.i./acre.

7. A method according to claim 1, which is part of a program comprising several fungicide applications, not all applications comprising dodecylguanidine.

8. A method according to claim 1, for protecting peanut plants against early leaf spot.

9. A method according to claim 1, for protecting peanut plants against late leaf spot.

10. A composition useful against peanuts early leaf spot and late leaf spot comprising dodecylguanidine.

11. A composition according to claim 10, wherein the dodecylguanidine is in the form of a salt.

12. A composition according to claim 11, wherein the salt is chosen amongst hydrochloride and acetate.

13. A composition according to claim 10, which also comprises another fungicide chosen amongst tebuconazole and propiconazole.

14. A composition according to claim 10, which comprises between 20 and 90% w/w dodecylguanidine.
